(19) United States
(12) Patent Application Publication
(10) Pub. No.: US 2005/0046630 A1
(43) Pub. Date: Mar. 3, 2005

(54) Designable layout animations

(76) Inventors: Kurt Jacob, Redmond, WA (US); Peter Faraday, Seattle, WA (US); Sujal Parikh, Seattle, WA (US); Leonardo Blanco, Redmond, WA (US); Kenneth Young, Sammamish, WA (US); Matthew Calkins, Seattle, WA (US)

Correspondence Address: WOODCOCK WASHBURN LLP, ONE LIBERTY PLACE - 46TH FLOOR, PHILADELPHIA, PA, 19103, US

(21) Appl. No.: 10/651,896

(22) Filed: Aug. 29, 2003

(51) Int. Cl. G06T 15/70

(52) U.S. Cl. 345/475; 345/474; 345/473

(57) ABSTRACT

An transition information is created and stored for layout animations. This transition information is then applied to layout changes at runtime when a trigger event occurs to animate a change in a layout. In one embodiment, transition information is provided in a script. The script details how a layout transition will occur in a layout during runtime. When the transition does occur, the transition information specified is applied to the transition, thereby allowing the user experience to be enhanced. In this way, animation is integrated in providing a graphical display.

### FIELD OF THE INVENTION

The present invention relates to the field of graphical displays. Specifically, the present invention relates to the field of animating layout changes in graphical displays.

### BACKGROUND OF THE INVENTION

In modern user interfaces, user controls are often placed on a user display by storing information about the user control in a layout form which is displayed using a layout algorithm. The layout algorithm allows the form to compensate for resize actions and for adding or removing controls. When a change is made to the layout form, this change is reflected on the display.

For example, layouts may be used to provide a toolbar with controls on a display for a user. The contents of the tool bar (for example, some description of the controls) is contained in a layout form. A layout algorithm uses the contents of the layout form to determine what will be displayed on the screen. For example, a control on a tool bar may have associated text which labels the control. If there is room in the toolbar for the complete text of each control to be displayed, the layout algorithm may display the complete text of each control. If there is not enough room in the toolbar, the layout algorithm may display the controls differently (e.g. in a smaller area) and may abbreviate the text of the control.

The toolbar may be resized. Additionally, controls may be added to or removed from the toolbar. When such a change occurs, the contents of the layout form are changed. The layout algorithm is then used to determine any changes in the display of the toolbar.

The change in the layout form is instantaneously reflected in the display. However, this may be confusing for a user, who may not have time to notice and understand what is being changed. This is illustrated in FIG. 1a and FIG. 1b. In FIG. 1a, the start positions of element 1010 on display 1000, and of a toolbar 1020 with controls 1030 are depicted. Element 1010 is to be moved onto the toolbar. This movement, when it occurs, will be reflected in the layout for toolbar 1020. As shown in FIG. 1b, which is successive in time to FIG. 1a, the changed layout is reflected immediately in the changed positions of element 1010, toolbar 1020, and controls 1030 on display 1000.

Animating such layout changes using linear interpolation eases these transitions, maintaining a sense of consistency for the user. Some prior art systems implement such linear interpolation between the old and new positions of an element when a layout is being changed. A linear path is shown between the old position of an element which is being moved and the new position of the element. This allows the user to see an element as it is being changed from one size or position to another. However, this linear interpolation has many drawbacks. It is a simple and non-extensible interpolation. The linear interpolation does not allow the designer of the graphical user interface to have any control over the animation of the change being made. Also, the linear interpolation does not allow the designer to trigger animations on properties other than those that are modified in the layout form. Layout changes affect only a predetermined subset of the properties of an element. For example, many prior art systems allow layout to effect only the size and position of an element. Thus, performing a linear interpolation between such changes may be possible, however, animating a change in other properties of the element will not be possible. The linear interpolation functionality is not extensible to other properties.

An example of the linear interpolation is illustrated in FIG. 2a through FIG. 2d. In FIG. 2a, the start positions of element 1110 on display 1100, and of a toolbar 1120 with controls 1130 are depicted. Element 1110 is to be moved onto the toolbar. When this movement does occur, the change is reflected in the layout for toolbar 1120. As shown in FIG. 2b, the changed layout is reflected immediately in the new positions of controls 1130. The movement of element 1110 is animated using linear interpolation. As shown in FIGS. 2b and 2c, which depict the display 1100 at successive times, element 1110 moves from its original location (seen in FIG. 2a) towards its final location. In FIG. 2c, the path of element 1110 is shown as a dotted line 1190. In FIG. 2c, the former position of element 1110 is designated as the dashed-line box 1192 and the destination of element 1110 is designated with dashed-line box 1194. In FIG. 2d, element 1110 is in its final location in the toolbar 1120.

However, there is no way in the prior art for a designer of a user interface to control this linear interpolation animation. Additionally, as mentioned, designers can not trigger animations on properties other than those modified by layouts. The linear interpolation animation is also simple and does not provide a designer with flexibility in designing a transformation which can enhance the user's experience by animating a layout change.

### SUMMARY OF THE INVENTION

In view of the foregoing, the present invention provides methods and systems for an authoring experience or a display implementation which allows transition information to be created for layout animations. This transition information is applied to layout changes when certain layout change triggers are encountered, to animate a change in a layout. The layout may be provided in a script, which provides information regarding the layout transition.

Thus, increased flexibility in animating layout changes is provided to graphical display designers. Other features of the present invention are described below.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIGS. 1a and 1b are block diagrams of the movement of an element on a display at a beginning time and a successive time according to the prior art;

FIGS. 2a, 2b, 2c, and 2d are block diagrams of the movement of an element on a display at two successive times according to the prior art;

FIG. 3 is a block diagram of an exemplary computing environment in which aspects of the invention may be implemented;

FIG. 4 is a diagram showing a motion path according to one embodiment of the invention;

FIGS. 5a and 5b are each block diagrams showing the application of a motion path to the movement of an element according to one embodiment of the invention;

FIGS. 6a, 6b, 6c, and 6d are block diagrams of the movement of an element on a display at a beginning time and three successive times according to one embodiment of the invention;

FIGS. 7a, 7b, 7c, and 7d are block diagrams of the movement of an element on a display at a beginning time and three successive times according to one embodiment of the invention; and

FIG. 8 is a flow diagram showing the process animating a change in a graphic display in accordance with aspects of the invention.

### DETAILED DESCRIPTION OF ILLUSTRATIVE EMBODIMENTS

Overview

In order to provide for animation in layout changes, an authoring experience is provided which allows transition information to be created for layout animations. This transition information is then applied to layout changes at runtime to animate a change in a layout.

In one embodiment, transition information is provided in a script. The script details how a layout transition will occur in a layout during runtime. When the transition does occur, one or more specific graphical elements to be added to, removed from, or moved within a layout are designated, as well as the change data for the graphical element. The transition information specified in the script is applied to the transition, thereby allowing the user experience to be enhanced.

Graphical elements may be moved from outside of a layout into a layout, from inside a layout to outside of it. A special case of this is when an element is moved from one layout to another. Additionally, a graphical element may be moved within a given layout.

In this way, forms and animation may be integrated in providing a graphical display.

Exemplary Computing Environment

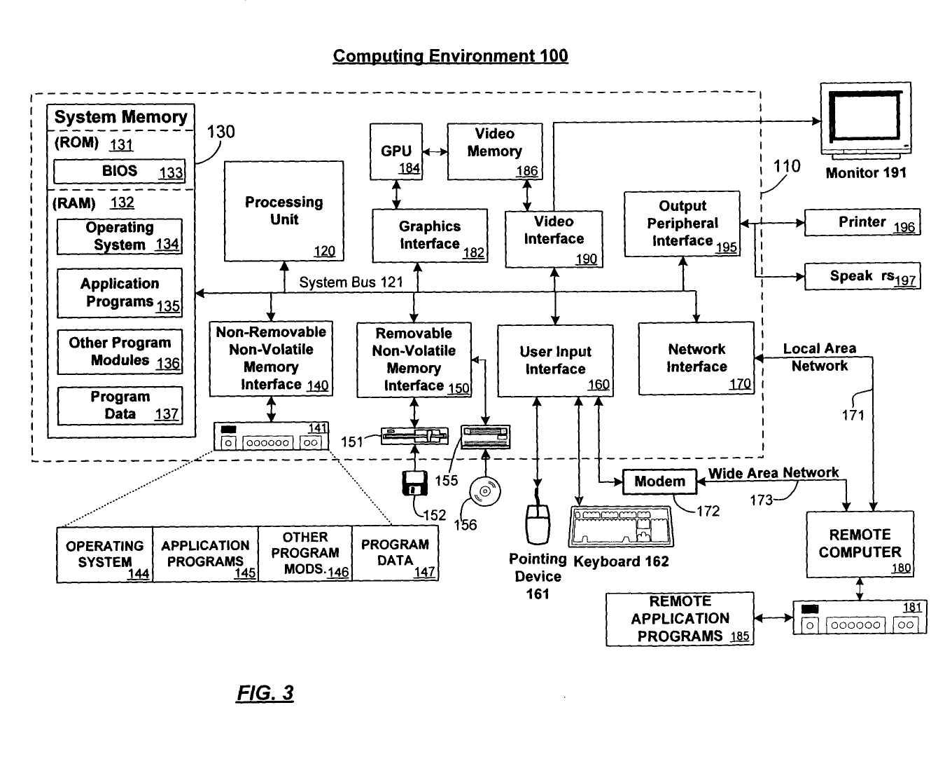

FIG. 3 illustrates an example of a suitable computing system environment 100 in which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network or other data transmission medium. In a distributed computing environment, program modules and other data may be located in both local and remote computer storage media including memory storage devices.

With reference to FIG. 3, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 110 typically includes a variety of computer readable media. Computer readable media can be any available media that can be accessed by computer 110 and includes both volatile and non-volatile media, removable and non-removable media. By way of example, and not limitation, computer readable media may comprise computer storage media and communication media. Computer storage media includes both volatile and non-volatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or non-volatile memory such as ROM 131 and RAM 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 3 illustrates operating system 134, application programs 135, other program modules 136, and program data 137.

The computer 110 may also include other removable/non-removable, volatile/non-volatile computer storage media. By way of example only, FIG. 3 illustrates a hard disk drive 140 that reads from or writes to non-removable, non-volatile magnetic media, a magnetic disk drive 151 that reads from or writes to a removable, non-volatile magnetic disk 152, and an optical disk drive 155 that reads from or writes to a removable, non-volatile optical disk 156, such as a CD-ROM or other optical media. Other removable/non-removable, volatile/non-volatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media, discussed above and illustrated in FIG. 3, provide storage of computer readable instructions, data structures, program modules and other data for the computer 110. In FIG. 3, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 3. The logical connections depicted include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 3 illustrates remote application programs 185 as residing on memory device 181. It will be appreciated that the network connections shown are exemplary and other means of establishing a communications link between the computers may be used.

Exemplary Distributed Computing Frameworks Or Architectures

Various distributed computing frameworks have been and are being developed in light of the convergence of personal computing and the Internet. Individuals and business users alike are provided with a seamlessly interoperable and web-enabled interface for applications and computing devices, making computing activities increasingly web browser or network-oriented.

For example, Microsoft®'s .NET platform includes servers, building-block services, such as web-based data storage, and downloadable device software. Generally speaking, the NET platform provides (1) the ability to make the entire range of computing devices work together and to have user information automatically updated and synchronized on all of them, (2) increased interactive capability for web sites, enabled by greater use of XML rather than HTML, (3) online services that feature customized access and delivery of products and services to the user from a central starting point for the management of various applications, such as e-mail, for example, or software, such as Microsoft® Office®, (4) centralized data storage, which will increase efficiency and ease of access to information, as well as synchronization of information among users and devices, (5) the ability to integrate various communications media, such as e-mail, faxes, and telephones, (6) for developers, the ability to create reusable modules, thereby increasing productivity and reducing the number of programming errors, and (7) many other cross-platform integration features as well.

While exemplary embodiments herein are described in connection with software residing on a computing device, one or more portions of the invention may also be implemented via an operating system, API, or a “middle man” object between a coprocessor and requesting object, such that services may be performed by, supported in, or accessed via all of NET's languages and services, and in other distributed computing frameworks as well.

Animating a Change in Layout on A Graphical Display

In order to animate a change in layout on a graphical display, an authoring experience is presented to a designer which allows the designer to specify how layout changes will be animated. The designer can store transition information which describes the requested transition of an element. When the transition information is applied to an element being moved, the move is animated according to the transition information. Additionally, information regarding other changes to be animated in the display and any other non-display effects to be presented (such as sound effects, for example) are contained in the transition information.

The application of the transition information occurs when a specific event (such as the movement of an element) occurs. In one embodiment, a helper object is associated with the element. In a system where containers contain elements, the helper object may be associated with a container. When an trigger event occurs, the helper object performs the animation for the event according to the transition information. In this way, a designer can prescribe an animation to be used when a trigger event occurs. Trigger events may include, without limitation, the movement of an element, resizing of an element, adding or removing of an element or set of elements from a layout, or a resize of the layout container such that its contents are caused to re-layout.

Transition Animation

When an element is moved on a layout, certain properties of the element may change. The location of the element may change—either or both of the x and y coordinates of the element may change. Additionally, the x and y coordinates of the element may stay the same, but the width and/or height of the element may change. This may also result in movement of the element from its original position and trigger layout changes. In addition, the parent property of an element may change if the element is moving into, out of, or between layouts Other properties of an element may also change. For example, the color or transparency of an element may change. For example, a control on a toolbar which is not present in a first layout may gradually appear (transitioning from total transparency to total opacity) in the toolbar. Movement of controls already present in the toolbar may be needed to accomplish this.

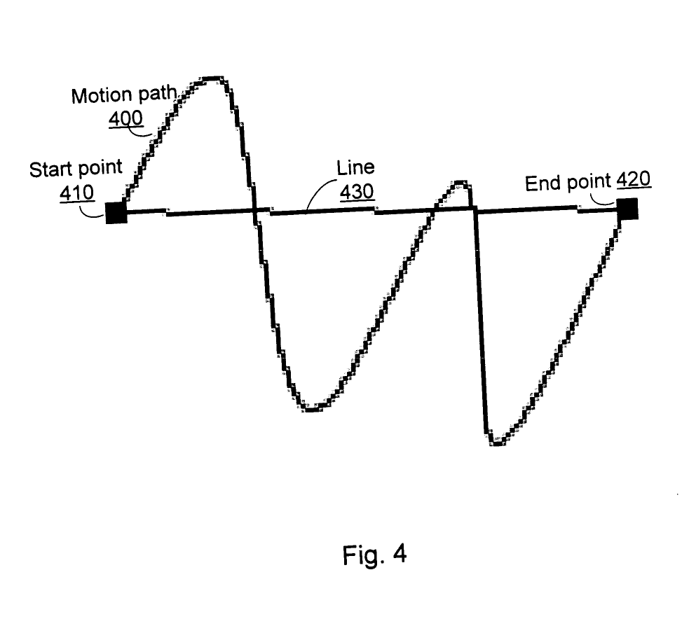

The designer specifies the animation which can accompany such changes, in one embodiment, by storing transition information. For example, a transition may be along a Bezier curve from the start position to the end position. The designer specifies the path for the element being moved to follow. FIG. 4 is a depiction of an example motion path 400 which may be stored as part of transition information for an animation. Start point 410 and end point 420 of motion path 400 are defined. A line 430 connecting the beginning and end point of the path can also be calculated. In one embodiment, the path is specified in a script. The script is stored and applied when a move occurs.

When the move occurs, the start state of the element is determined, including the position (x and y coordinates) and width and height of the element in its original location. An end property state is also calculated, similarly including position and size the element will occupy in its new position. The transition information from the script is used to animate the requested transition.

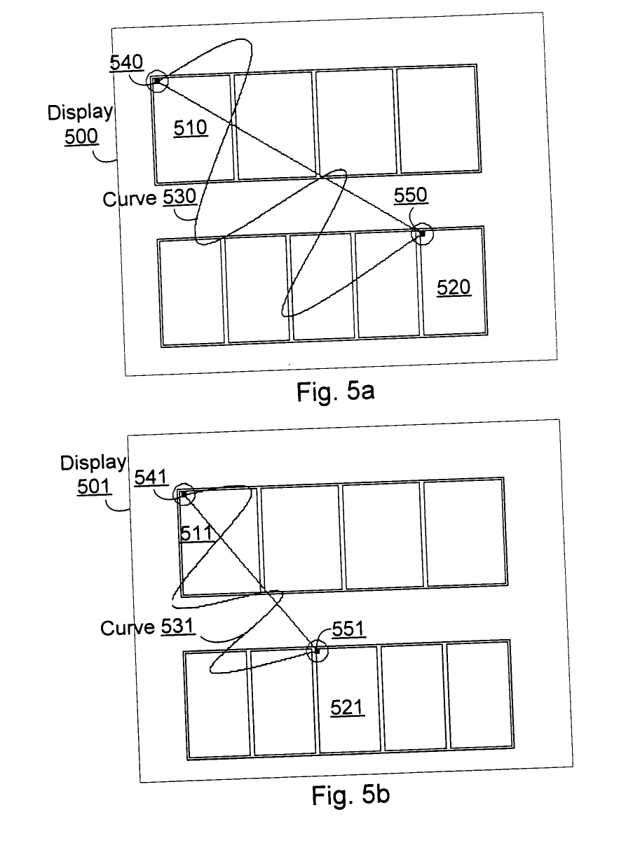

For example, in FIG. 5a, an element is being moved in display 500 from position 510 to position 520. If the motion path from FIG. 4 is applied, the animation of the move will proceed along curve 530. The path from FIG. 4 is adjusted in several ways. First, the path is adjusted by rotating it so that the line connecting the beginning and end point of the path (line 430 in FIG. 4) is aligned with a line between the upper left corner 540 of position 510 and the upper left corner 5550 of position 520. Additionally, the path is scaled so that the start and end points of the path are aligned with the upper left corner 540 of position 510 and the upper left corner 550 of position 520. When the element is moved, it will follow the path 530.

The same transition may be applied to another situation. FIG. 5b depicts another possible use of the motion path of FIG. 4. In FIG. 5b, an element is being moved in display 501 from position 511 to position 521. Similarly to the situation in FIG. 5a, when the motion path from FIG. 4 is applied, the animation of the move will proceed along curve 531. The path from FIG. 4 is again adjusted by rotating it so that the line connecting the beginning and end point of the path (line 430 in FIG. 4) is aligned with a line between the upper left corner 541 of position 511 and the upper left corner 551 of position 521, and by scaling it so that the start and end points of the path are aligned with the upper left corner 541 of position 511 and the upper left corner 551 of position 521. Thus it can be seen how stored transition information may be applied in different situations.

Other effects may be added to this animation. For example, the size of the element may change during the animation. First, the size of the element initially may be different from the size of the element in its new location. The animation of the transition may include a transition from one size to another. The same is true if the shape of the element changes. Additionally, even if the element is to be the same size at the destination as it originally was before the element was moved, animations may include changes in the size or shape or other changes in the appearance of the element during the transition. The duration of the transition may also be controlled.

Phases of Element Movement

In one embodiment of the invention, three phases of an animation may be discerned.
(1) Removal—the removal of the element from its original position in the graphical display;
(2) Transition—the animation which moves the element from its original position to the new position; and
(3) Reservation—the reservation of space for the element's new position.

When an element is located in a graphical display, space is reserved for the element. The reservation of space in a layout may trigger movement of other elements in the layout in order to create the space for the element. While this reservation is instantaneous to the layout engine, according to one embodiment of the invention the designer may create a transition which, when applied, causes a gradual animation of the change. Thus, to a user, the change will appear gradual. The designer may also cause the user's view of the change to be instantaneous. The removal of an element, similarly, may trigger movement of other elements in the layout in order to use the vacated space. Again, the change may be animated to appear instantaneous or gradual.

The removal phase is the phase of animation which removes the element from its original position. This may trigger movement of other elements. For example, in a layout with numerous elements which equally divide available space, the removal of an element may cause shifting of the elements. If an object is moved within an existing container, the removal phase and the reservation phase in some systems will occur at the same time and the phases may necessarily be interrelated.

The transition phase, which has been discussed above, is the phase in which the transition of the element between the original location of the element and the new location for the element occurs. As discussed, this may include resizing, animation of a transition path, and other animation effects.

The reservation phase is the reservation of a new space for the element at the destination for the element. Again, this may trigger movement of other elements, such as, where the elements in a layout equally divide space.

In one embodiment, authors can specify in the transition information three phases of an animation to correspond with these three phases. The phases may overlap—for example, the transition phase may begin and proceed for some time before the removal phase begins, and then the transition phase may continue after the reservation phase is triggered, making room for the element at the final destination.

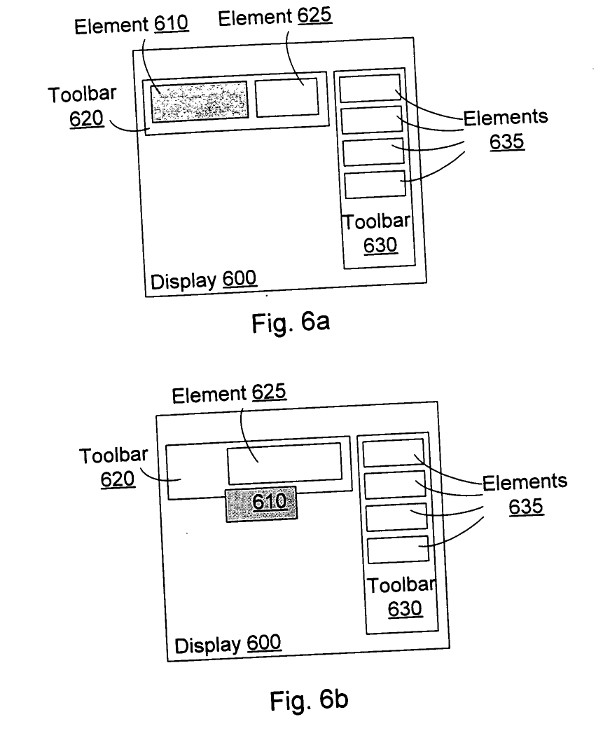

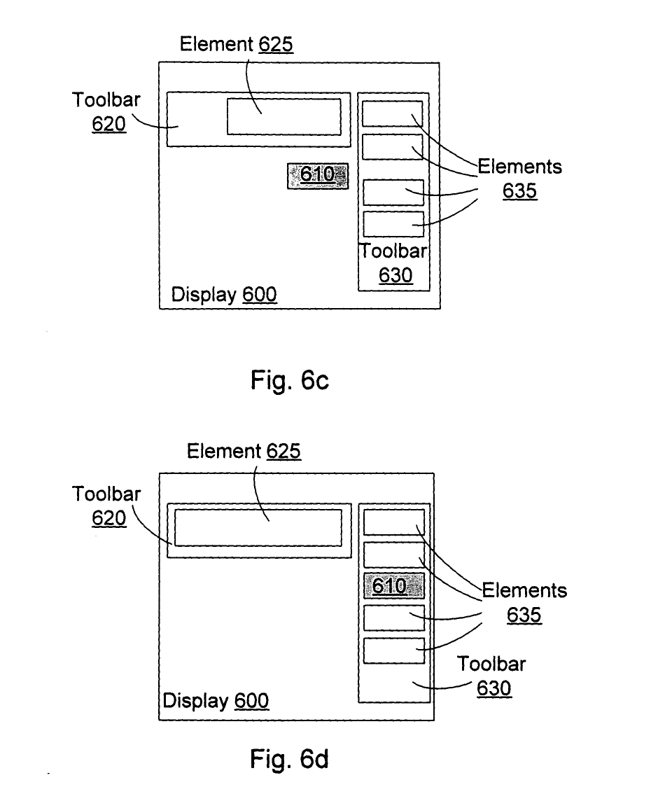

An example of this interleaving of phases is shown in FIGS. 6a through 6d, which depict successive images during a gradual move of an element from one toolbar to another. In FIG. 6a, element 610 on display 600 is located in toolbar 620. Toolbar 630 will be the eventual destination of element 610. Toolbar 620 also contains element 625 and toolbar 630 also contains elements 635.

In FIG. 6b, the transition phase has begun—element 610 is moving to toolbar 630 and shrinking in size. At the same time, the removal phase has also been triggered, and element 625 is expanding in size to fill toolbar 620. In FIG. 6c, the transition phase continues element 610 continues to move to toolbar 630 and shrink in size to fit in its eventual location. The removal phase also continues. Additionally, the reservation phase has begun—elements 635 in toolbar 630 have begun shifting downwards to make room for element 610. In FIG. 6d, all phases are complete —element 625 occupies all of toolbar 620, and element 610 and elements 635 are positioned in toolbar 630. By interleaving the phases in this way, a designer can create an animation which aids comprehension for a user. While in FIGS. 6a-6d element 610 changes in size but not color or orientation as it moves to its new position in toolbar 630, changes in color, orientation, and other display effects can be applied using the transition information according to the present invention.

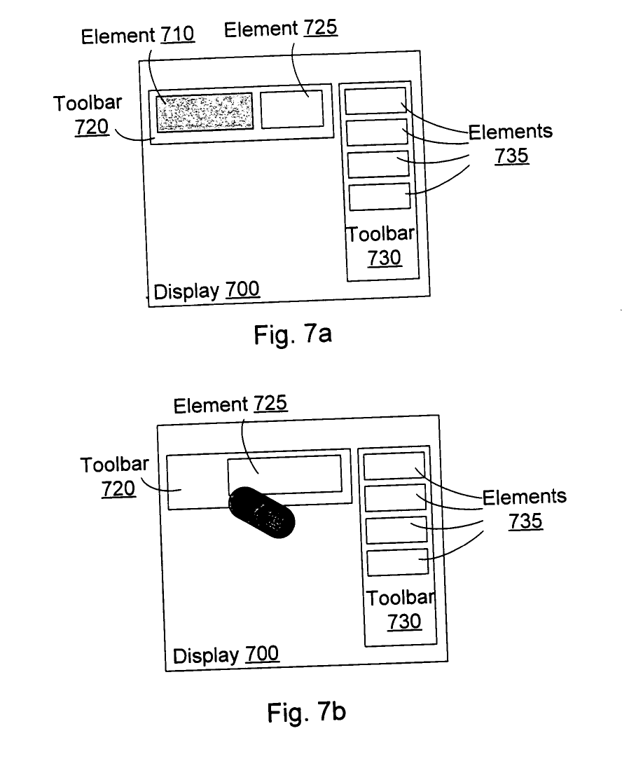

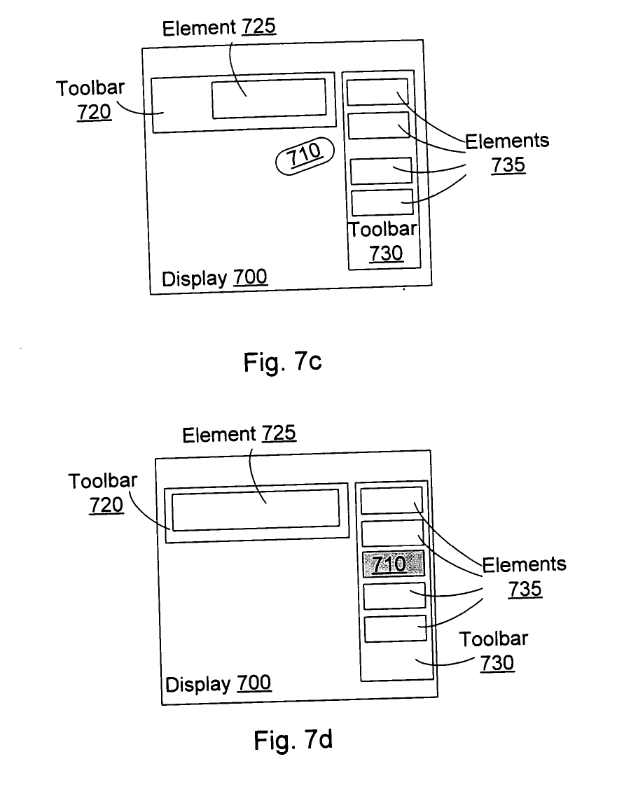

For example, in FIGS. 7a through 7d, a gradual move of an element from one toolbar to another with color, shape, and orientation changes is shown. As in FIG. 6a, in FIG. 7a, element 710 on display 700 is located in toolbar 720. Toolbar 730 will be the eventual destination of element 710. Toolbar 720 also contains element 725 and toolbar 730 also contains elements 735.

In FIG. 7b, the transition phase has begun—element 710 is moving to toolbar 730 and shrinking in size. Additionally, element 710 is being animated to change colors and to rotate. Therefore in FIG. 7b, element 710 has changed color and orientation. At the same time, the removal phase has also been triggered, and element 725 is expanding in size to fill toolbar 720. In FIG. 7c, the transition phase continues element 710 continues to move to toolbar 730 and has again changed color. The removal phase also continues. Additionally, the reservation phase has begun—elements 735 in toolbar 730 have begun shifting downwards to make room for element 710. In FIG. 7d, all phases are complete—element 725 occupies all of toolbar 720, and element 710 and elements 735 are positioned in toolbar 730. Thus it can be seen that element 710 is not undergoing a linear interpolation. This illustration is not meant to be limiting, other changes in the element being transitioned, and in the other elements in the display, are contemplated, as are additional user effects, including such non-graphical display effects such as sound effects.

Method for Animating

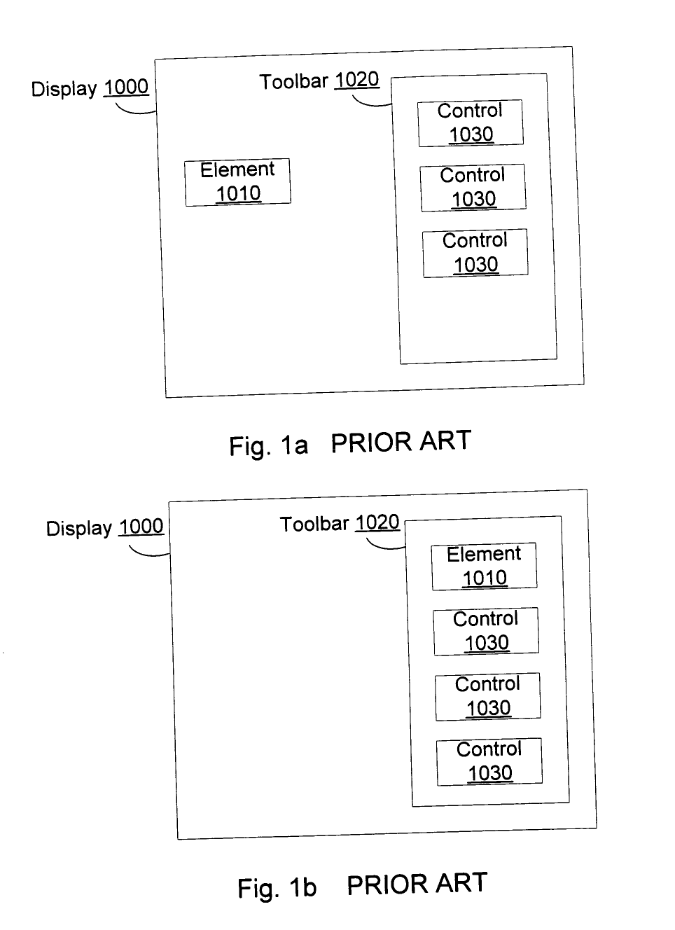

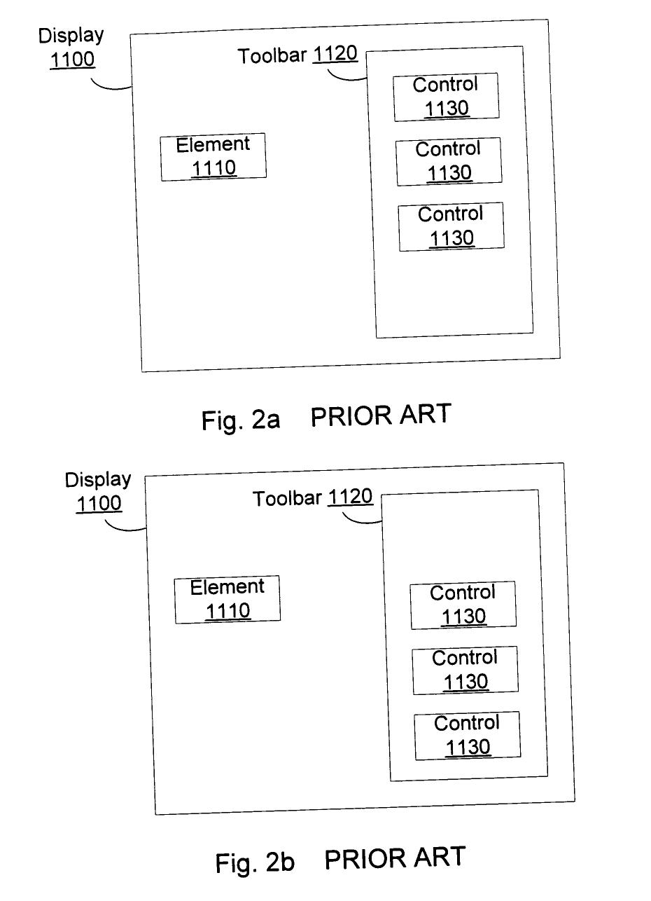

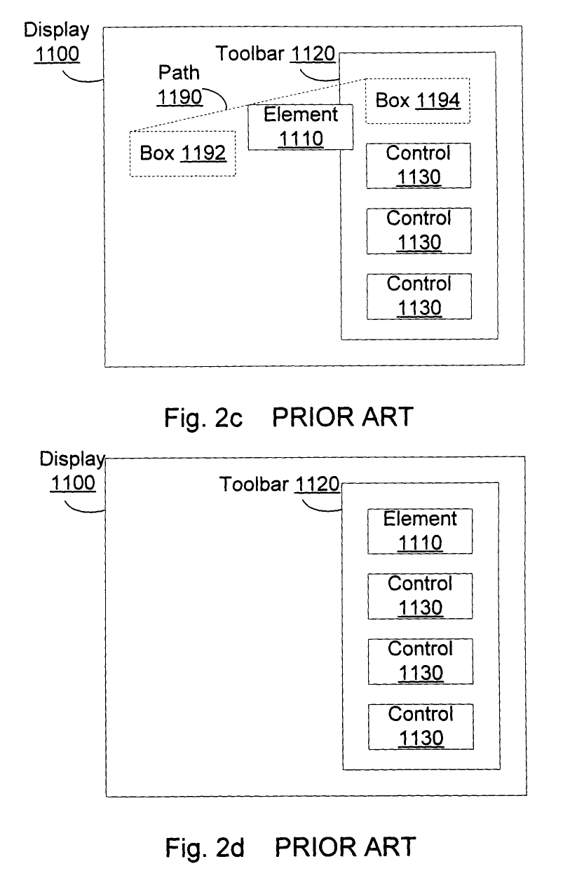

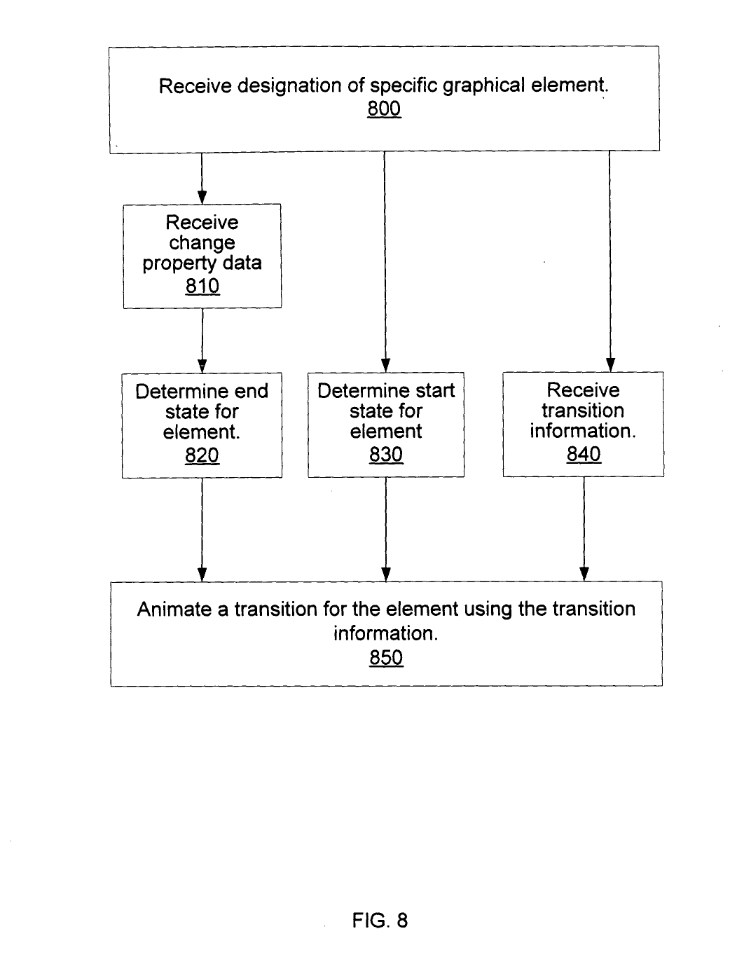

In one embodiment, animation is provided using the transition information provided by a designer (or otherwise provided). FIG. 8 shows a flow diagram for a method for animating a change in a graphical layout according to this embodiment of the invention. A designation of a specific graphical element is received in step 800. In step 810, change property data describing the changes occurring to the element is received. The element's end state, including, on one embodiment, position and size data for the element, is determined in step 820. In step 830, the start state of the element is determined. Transition information is received in step 840. In step 850, the transition information is used to animate a transition for the element. In one embodiment, the computed layout changes which describe the “before” and “after” state resulting from a change are assembled along with the designer instructions (the transition information) in order to animate a transition which takes into account any layout changes and any other changes in the properties of an element, along with the transition information. Transition information may include information regarding the animation of the graphical element which is being changed. Other graphical elements in layouts may also be involved in the change, and in that case, the transition information also includes information regarding these other changes. Transition information also includes information regarding other animation effects, such as other animations on the graphical display and such as non-graphical effects such as sound effects, which may not be presented through the graphical display but through other means, such as, with reference to FIG. 1, speakers 197.

In one embodiment, transition information includes at least one trigger event, and the animation of the transition occurs only when a trigger event has occurred.

Animation Types

In a preferred embodiment, four animation types are supported. Transition information for any animation type may be designed by a designer. These animation types describe different changes which can occur in a display which includes one or more layouts. The animation types are triggered on different events. The animation types are:
(1) Enter Layout—an element goes from not being displayed to being present in a layout;
(2) Exit Layout—an element goes from being present in a layout to not being displayed;
(3) Layout Delta—an property change causes a change in layout; and
(4) Layout-to-Layout—an element transitions from one layout to another.

The Enter Layout animation type describes the case where an element not displayed on the display transitions to being displayed on the screen. Examples of animation for this case include the element “flying” in from off-screen (e.g. the element enters from the side of the screen and travels to its new location). Other examples of Enter Layout animation can include: a fade in of the element, or the element growing from zero size. Combinations of these techniques may be used. Enter Layout animations may be triggered when an element which does not appear on the display is to be placed on the display.

The Exit Layout animation type describes the reverse situation, and the techniques which can be used to animate it are related. The element may fly off-screen, may shrink to zero-size, or may fade out. Again, combinations of these techniques may be used. Exit Layout animations may be triggered when an element which appears on the display is to be removed from the display.

In order to animate Layout Delta animations and Layout-to-Layout animations, as described above, a smooth transition between the initial state and the final state, along with an animation of moving elements may be animated. Layout Delta animations may be triggered when the size or shape of the layout changes, or when the size or position of one or more layout elements changes. Layout-to-Layout animations are triggered when one or more elements are moved from one layout to another.

### CONCLUSION

As mentioned above, while exemplary embodiments of the present invention have been described in connection with various computing devices, the underlying concepts may be applied to any computing device or system.

The various techniques described herein may be implemented in connection with hardware or software or, where appropriate, with a combination of both. Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device will generally include a processor, a storage medium readable by the processor (including volatile and non-volatile memory and/or storage elements), at least one input device, and at least one output device. The program(s) can be implemented in assembly or machine language, if desired. In any case, the language may be a compiled or interpreted language, and combined with hardware implementations.

The methods and apparatus of the present invention may also be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes an apparatus for practicing the invention. When implemented on a general-purpose processor, the program code combines with the processor to provide a unique apparatus that operates to invoke the functionality of the present invention. Additionally, any storage techniques used in connection with the present invention may invariably be a combination of hardware and software.

While the present invention has been described in connection with the preferred embodiments of the various figures, it is to be understood that other similar embodiments may be used or modifications and additions may be made to the described embodiments for performing the same function of the present invention without deviating therefrom. Therefore, the present invention should not be limited to any single embodiment, but rather should be construed in breadth and scope in accordance with the appended claims.

1. A method for animating a change in a graphical layout comprising at least one graphical elements on a graphical display, the method comprising:
receiving a designation of a specific graphical element from among said at least one graphical elements;
determining a start property state for said specific graphical element;
receiving change data for said specific graphical element;
determining an end property state for said specific graphical element;
receiving transition information describing an animated transition for a graphical element;
animating a transition of said specific graphical element from said start property state to said end property state according to said transition information.

2. The method of claim 1, where said transition information comprises transition trigger data comprising at least one trigger events, and where said step of animating a transition occurs when a trigger event from said at least one trigger events occurs.

3. The method of claim 2, where one of said at least one trigger events comprises the moving of an element into said graphical layout.

4. The method of claim 2, where one of said at least one trigger events comprises the moving of an element out of said graphical layout.

5. The method of claim 2, where one of said at least one trigger events comprises the moving of an element within said graphical layout.

6. The method of claim 2, where said graphical layout comprises at least one container, and where one of said at least one trigger events comprises the changing of a container size.

7. The method of claim 2, where said at least one trigger events comprises the resizing of at least one of said at least one graphical elements.

8. The method of claim 1, where said transition information comprises removal information describing the animation of the removal of said graphical element in said start property state.

9. The method of claim 1, where said transition information comprises reservation information describing the animation of the reservation of space for said graphical element in said end property state.

10. The method of claim 1, where said transition information comprises transition information describing the animation of the transfer of said graphical element from said start property state to said end property state.

11. The method of claim 1, where said transition information comprises transition information describing other changes on said graphical display.

12. The method of claim 1, where said transition information comprises transition information describing sound effects.

13. A computer-readable medium having computer-executable instructions for instructing a computer to perform the acts recited in claim 1.

14. A graphics rendering system for rendering a graphical display comprising a graphical layout comprising at least one graphical elements, said system comprising:
storage for storing transition information describing an animated transition for a graphical element;
graphical element state determination module for determining a start property state and an end property state for a specific graphical element; and
animation module for animating a transition of said specific graphical element from said start property state to said end property state according to said transition information.

15. The graphics rendering system of claim 14, where said transition information comprises transition trigger data comprising at least one trigger events, and where said animation of a transition occurs when a trigger event from said at least one trigger events occurs.

16. The graphics rendering system of claim 15, where one of said at least one trigger events comprises the moving of an element into said graphical layout.

17. The graphics rendering system of claim 15, where one of said at least one trigger events comprises the moving of an element out of said graphical layout.

18. The graphics rendering system of claim 15, where one of said at least one trigger events comprises the moving of an element within said graphical layout.

19. The graphics rendering system of claim 15, where said graphical layout comprises at least one container, and where one of said at least one trigger events comprises the changing of a container size.

20. The graphics rendering system of claim 15, where said at least one trigger events comprises the resizing of at least one of said at least one graphical elements.

21. The graphics rendering system of claim 14, where said transition information comprises removal information describing the animation of the removal of said graphical element in said start property state.

22. The graphics rendering system of claim 14, where said transition information comprises reservation information describing the animation of the reservation of space for said graphical element in said end property state.

23. The graphics rendering system of claim 14, where said transition information comprises transition information describing the animation of the transfer of said graphical element from said start property state to said end property state.

24. The graphics rendering system of claim 14, where said transition information comprises transition information describing other changes on said graphical display.

25. The graphics rendering system of claim 14, where said transition information comprises transition information describing sound effects.
